(19) United States
(12) Patent Application Publication
(10) Pub. No.: US 2026/0113606 A1
(43) Pub. Date: Apr. 23, 2026

(54) A SYSTEM AND METHOD FOR INTEGRATING DIGITAL TWINS INTO VEHICULAR AD HOC NETWORKS (VANET) WITH COMPUTER-AIDED MACHINE LEARNING

(71) Applicant: BTS KURUMSAL BILISIM TEKNOLOJILERI ANONIM SIRKETI, Atasehir/Istanbul (TR)

(72) Inventors: Gökhan YURDAKUL, Üsküdar/Istanbul (TR); Sarah AL-SHAREEDA, Sariyer/Istanbul (TR); Kübra DURAN, Sariyer/Istanbul (TR); Berk CANBERK, Sariyer/Istanbul (TR); Özgür PALANTÖKEN, Pendik/Istanbul (TR)

(21) Appl. No.: 19/116,350

(22) PCT Filed: Jul. 22, 2024
(86) PCT No.: PCT/TR2024/050858

§ 371 Date: Mar. 27, 2025

(30) Foreign Application Priority Data
Feb. 14, 2024 (TR) 2024/001717

(51) Int. Cl. H04W 4/46; H04W 24/06; H04W 84/18

(52) U.S. Cl. CPC H04W 4/46; H04W 24/06; H04W 84/18

(57) ABSTRACT

The invention relates to a system for integrating digital twins into Vehicular Ad Hoc Networks (VANET) with computer-aided machine learning and data analysis techniques, and a method for operating said system. The invention is used in all fields of transport systems, in particular VANET.

### TECHNICAL FIELD

The invention relates to a system for integrating digital twins into Vehicular Ad Hoc Networks (VANET) with computer-aided machine learning and data analysis techniques, and a method for operating said system. The invention is used in all fields of transport systems, in particular VANET.

### STATE OF THE ART

Applications and algorithms in Vehicular Ad Hoc Networks (VANET) use wireless communication technologies such as WiFi and cellular 4G/5G networks to enable real-time data exchange and cooperation between various elements, primarily within a vehicle-to-everything (V2X) communication framework.

The dynamic and mobile environment of vehicular ad hoc networks (VANET) in the present art causes frequent changes and interruptions in the dynamic network topology. This makes it difficult to ensure a reliable connection and communication and creates delays and interruptions in data exchange, which is critical for the functioning of intelligent transport systems.

In the state of the art, VANETs are required to support many vehicles, generate real-time data and exchange data. This becomes a significant and major obstacle that requires solutions for scalability, handling the increasing volume of data and ensuring effective communication between many network units. Furthermore, security and privacy are critical issues in VANETs, requiring strong mechanisms especially to protect sensitive information such as location data and vehicle status. The development of effective security measures for protecting sensitive data without compromising the efficiency of data exchange is becoming a major technical challenge.

VANET applications in the state of the art have strict quality of service (QOS) requirements, including low latency and high reliability for timely and accurate data transmission. This in turn requires improved algorithms and communication protocols to ensure consistent quality of service (QOS) in a dynamic and diverse vehicle network environment. Furthermore, simulation environments commonly used in the development and testing of said VANET applications do not accurately represent real-world scenarios. Thus, the limited interaction between simulated elements and real drivers in traffic reduces test validity and requires more accurate real-time emulation environments.

The literature in the present art generally focuses on certain aspects of virtual networks and certain types of distribution of digital twins. Thus, the lack of a comprehensive overview limits progress in this field by hindering the development of a common understanding of the various approaches and considerations in implementing digital twins for vehicular networks.

There is a need to develop novel systems and methods to overcome said disadvantages in the state of the art and those mentioned above and to improve the efficiency and reliability of vehicular ad hoc networks (VANET).

### SUMMARY OF THE INVENTION

The present invention relates to a system for integrating digital twins into Vehicular Ad Hoc Networks (VANET) with computer-aided machine learning and data analysis techniques, and to a method for operating said system, developed eliminate the above-mentioned disadvantages and to offer new advantages to the relevant technical field.

The invention is used in all fields of transport systems, in particular VANET. The digital twin architecture of the invention enables the optimization of Vehicular Ad Hoc Networks (VANET) by enabling communication between physical and virtual domains, thereby improving performance and operations in vehicular networks. The primary area of utilization of the invention is therefore the improvement of reliability and efficiency in transport systems through the implementation of vehicle networks with digital twin features.

The system according to the invention is designed to be continuously evolving, cyclical and dynamic, based on real-time feedback and data-driven artificial intelligence. Integrating such a system with existing infrastructure and ensuring user acceptance are some of the challenges that must be overcome for the system to reach its full potential. Despite these challenges, the synergy between physical and virtual components is supported by strong processing and artificial intelligence, and this synergy plays a critical role in the invention's capacity to transform intelligent transport systems. The invention overcomes these challenges.

The invention enables data collection from real VANETs and pre-processing with the physical layer unit included therein, and also provides an accurate representation of the physical world. It creates a virtual representation of the physical layer by using artificial intelligence and machine/deep learning technology (ML/DL) to analyze the data received with the virtual layer unit included therein. The invention makes informed decisions using analyses from the virtual layer unit and makes optimized recommendations for the physical world.

The invention enables continuous data flow and communication by facilitating the connection between the physical layer of the vehicle digital twin and the physical network (physical vehicular ad hoc networks (VANET) module). Furthermore, the invention supports cooperation and exchange of information by enabling virtual elements within the vehicle digital twin (DT) to communicate.

The invention utilizes the simulation, analysis and optimization capabilities of the virtual twin architecture to improve various aspects of VANETs, including connection, reliable communication, security measures, scalability, strict quality of service (QOS), guiding efficiency and data-driven decision making.

The invention addresses the limited focus of the literature in the present art to provide a comprehensive overview of the various/multiple approaches and considerations in practice for digital transformations for vehicle networks. It also creates a repository of information by collecting usage examples of virtual VANETs to improve the performance and efficiency of physical vehicular networks.

The system and method according to the invention provide insights into various distribution types and considerations to guide organizations and researchers in choosing the most appropriate approach for their needs. The invention compiles and analyses existing usage examples of virtual VANETs. Thus, it contributes to a better understanding of potential applications and benefits. It also examines the challenges of implementing digital twins (DT) in vehicular networks and reviews ongoing research efforts to address these challenges. It examines the performance of cloud-based, edge-based and hybrid twin architectures through a proof-of-concept case study, highlighting strengths and limitations. This analysis underlines the importance of choosing the appropriate distribution type to meet the physical network requirements.

### DESCRIPTION OF THE DRAWINGS

Embodiments of the invention, briefly summarized above and discussed in more detail below, may become apparent with reference to the exemplary embodiments of the invention illustrated in the accompanying drawings. It is to be noted, however, that the accompanying drawings only illustrate the typical embodiments of the invention and shall not be considered to limit its scope.

FIG. 1 A representative view of a diagram illustrating the working principle of the invention.

FIG. 2 A representative view of a diagram illustrating the working principle of the method according to the invention.

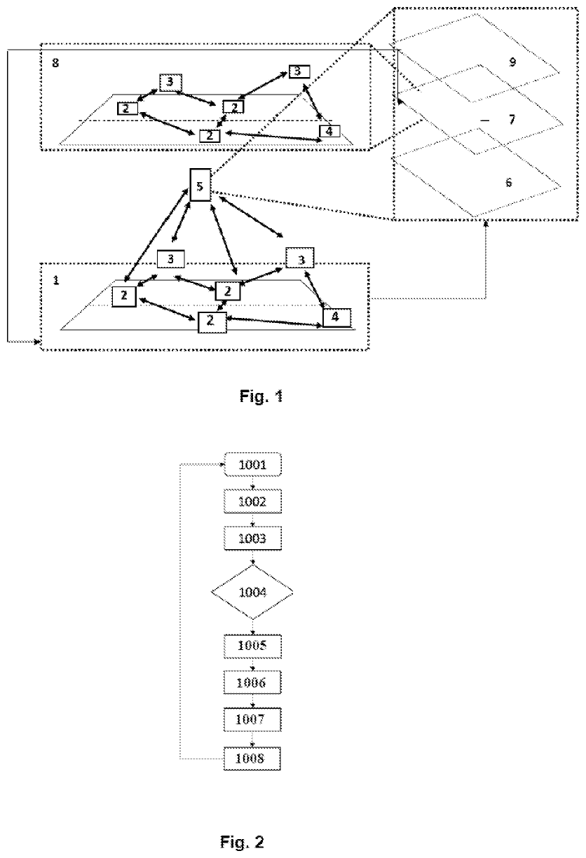

### DESCRIPTION OF THE REFERENCE IN THE DRAWINGS

For a better understanding of the invention, the corresponding reference numbers in the drawings are given below:
1. Physical Vehicular Ad Hoc Networks Module (Physical VANET module)
2. Vehicle
3. Infrastructure Unit
4. Pedestrian
5. Server
6. Physical Layer Unit
7. Virtual Layer Unit
8. Digital Vehicular Ad Hoc Networks Module
9. Decision Layer Unit
1001. The vehicles, infrastructure unit and pedestrians within the physical VANET module communicating and exchanging data over WiFi, cellular vehicle-to-vehicle (V2V), vehicle-to-infrastructure (V2I/I2V), vehicle-to-pedestrian (V2P/P2V) or infrastructure-to-pedestrian (I2P/P2I) connections
1002. The infrastructure unit collecting data received from the vehicles and pedestrians within its area and processing these data on the server
1003. Collecting and filtering said data received by the physical layer unit of the digital twin on the server
1004. Transmitting the filtered data outputs to the virtual layer unit and visualizing and simulating said data in the virtual layer unit
1005. Processing the data in the virtual layer unit with computer-aided machine learning and digital vehicular ad hoc networks (VANET) module in the decision layer unit
1006. Sending the results and decisions obtained in the server with the decision layer unit back to the infrastructure unit
1007. The infrastructure unit transmitting responses to the components within the physical VANET module
1008. Adjusting the status of the physical VANET module components according to the received data and updating the number of neighbours thereof and the location and speed data of these neighbours

### DETAILED DESCRIPTION OF THE INVENTION

The exemplary embodiments are described in more detail below with reference to the accompanying descriptions. However, the embodiments may take different forms and should not be construed as limited to the embodiments set out here. Instead, these exemplary embodiments are provided to ensure that this disclosure is comprehensive and its scope is fully communicated to those skilled in the art.

The invention relates to a network system and method in which communication and data exchange improves the functionality and compatibility of the vehicular ad hoc networks (VANET). The invention relates to a system for integrating digital twins into vehicular ad hoc networks (VANET) with computer-aided machine learning including at least one processor and data analysis techniques comprising;
at least one physical vehicular ad hoc networks (VANET) module (1), which includes vehicles (2), infrastructure unit (3) and pedestrians (4) for real-time data exchange and connection between network elements,
at least one non-autonomous (normal) or autonomous vehicle (2) which can communicate with its environment via WiFi or cellular connections,
at least one infrastructure unit (3) which can communicate with its environment and collect data using WiFi or cellular connections,
at least one pedestrian (4) communicating with the network elements with at least one mobile phone,
at least one cloud-based, edge-based or hybrid-based server (5) including vehicular ad hoc networks (VANET) therein,
at least one physical layer unit (6) which realizes the connection between the physical layer of the vehicular digital twins and the physical vehicular ad hoc networks (VANET) module (1) using intra-digital twin communication,
at least one virtual layer unit (7) which creates a virtual representation of the physical vehicular ad hoc networks (VANET) module (1) and processes the received data with computer-aided machine learning,
at least one simulated and real-time visualized digital vehicular ad hoc networks (VANET) module (8) which uses intra-digital twin networks to communicate with virtual elements within the vehicular digital twins,
at least one decision layer unit (9) which makes informed decisions using the analysis from the virtual layer unit (7) and makes optimized recommendations for the physical world through inter-twin communication.

The network elements referred to in the invention are vehicle-to-vehicle (V2V), vehicle-to-infrastructure (V2I/I2V), vehicle-to-pedestrian (V2P/P2V) and infrastructure-to-pedestrian (I2P/P2I) connections, but the embodiment is not limited thereto.

The physical vehicular ad hoc networks (VANET) module (1) includes the vehicles (2), infrastructure unit (3) and pedestrians (4). These elements are interconnected through wireless communication protocols, which are WiFi and cellular 4G or 5G, including vehicle-to-vehicle (V2V), vehicle-to-infrastructure (V2I/I2V), vehicle-to-pedestrian (V2P/P2V) and infrastructure-to-pedestrian (I2P/P2I) connections. This ensures the reliability of these communication connections in the uncertainty of real-world conditions. Thus, it contributes to the intelligent transport system (ITS).

In an embodiment of the invention, the infrastructure units (3) are roadside units (RSU), traffic lights, edge fog elements and access points, but the embodiment is not limited thereto.

The server (5) of the invention can be deployed in a flexible manner as a cloud-based, edge computing or hybrid system and becomes a processing center. This server (5) can be located in the cloud, at the edge, close to the infrastructure unit (3), or in a hybrid way both in the cloud and at the edge, but the embodiment is not limited thereto. By processing the raw data, said server (5) helps to create a digital twin, which is the digital equivalent of the physical VANET module (1). Furthermore, the server (5) is capable of processing the large data flow from the network nodes.

The physical layer unit (6) of the invention collects data from the physical VANET module (1) and provides pre-processing.

The invention relates to a method developed to enable the operation of a system for integrating digital twins into Vehicular Ad Hoc Networks (VANET) with computer-aided machine learning including at least one processor and data analysis techniques, said method comprises the following steps;
Communication and data exchange of the vehicles (2), infrastructure unit (3) and pedestrians (4) within the physical VANET module (1) over WiFi, cellular vehicle-to-vehicle (V2V), vehicle-to-infrastructure (V2I/I2V), vehicle-to-pedestrian (V2P/P2V) or infrastructure-to-pedestrian (I2P/P2I) connections (1001),
The infrastructure unit (3) collecting data received from the vehicles (2) and pedestrians (4) within its area and processing these data on the server (5) (1002),
Collecting and filtering said data received by the physical layer unit (6) of the digital twin on the server (5) (1003),
Transmitting the filtered data outputs to the virtual layer unit (7) and visualizing and simulating said data in the virtual layer unit (7) (1004),
Processing the data in the virtual layer unit (7) with computer-aided machine learning and digital vehicular ad hoc networks (VANET) module (8) in the decision layer unit (9) (1005),
Sending the results and decisions obtained in the server (5) with the decision layer unit (9) back to the infrastructure unit (3) (1006),
The infrastructure unit (3) transmitting responses to the components within the physical VANET module (1) (1007),
Adjusting the status of the physical VANET module (1) components according to the received data and updating the number of neighbours thereof and the location and speed data of these neighbours (1008).

In the invention, the virtual network twin (8), which is emulated in real time, can be displayed to transport system authorities and system users.

In step 1003 of the method according to the invention, the server (5) includes the real-time image of the physical VANET module (1) with the concept of a digital twin. At the server (5), the data from the physical layer unit (6) of the digital twin is filtered and only relevant and clean data passes through.

In step 1004 of the method according to the invention, after the filtering process, the virtual layer unit (7) is involved for visualization and simulation. In said step, SUMO (simulation of urban mobility analysis system) simulators are used to simulate the vehicle flow. The output from SUMO is saved as. xml files and the data is imported into the Kafka platform using the Traci interface and then visualized in the Grafana Web application. A virtual model is created, which accurately reflects the real world scenario. This enables a more realistic and detailed assessment of the traffic flow and the overall performance of the network.

In step 1005 of the method according to the invention, the data in the virtual layer unit (7) is processed in the decision layer unit (9) using computer-aided machine learning to enable the processes of predicting, optimizing and deciding the best actions and reactions. In addition, artificial intelligence algorithms and computer-aided machine learning, which can quickly adapt to the changing structure of the network and are capable of learning, enable the generation of effective solution strategies in complex traffic scenarios, which are compatible with the dynamics of the VANET network.

In steps 1007 and 1008 of the method according to the invention, the decisions generated by computer-aided machine learning are transmitted via infrastructure units (3) and these infrastructure units (3) distribute said responses to the components of the physical VANET module (1). Said physical VANET module (1) components are the vehicle (2), infrastructure unit (3) and pedestrian (4). The fact that these components accurately adjust their behaviour based on the received data creates an additional complexity, especially considering the diversity of the components of the network. Despite these challenges, the synergy between physical and virtual components is supported by computer-aided machine learning, and this synergy plays a critical role in the invention's capacity to transform intelligent transport systems.

Any feature disclosed in this description (including the appended claims, abstract and drawings) may be replaced by other alternative features which may have equivalent or similar purposes, unless explicitly stated otherwise. That is, unless explicitly stated otherwise, each feature is only one example of a set of equivalent or similar features.

The terminology used in this description is intended to be used only to describe the specific exemplary embodiments and is not intended to be limiting. As used herein, the context of the forms “a”, “at least”, “preferably” and “and/or” includes the plural forms unless explicitly stated otherwise.

The embodiments above are only intended to disclose the technical concept and features of the present invention, and the object of the present invention is to enable those skilled in the art to understand the content of the present invention and to implement the present invention, and the scope of the present invention is not limited thereto. The equivalent changes or modifications made in accordance with the spirit of the invention are intended to be included in the scope of the invention.

### INDUSTRIAL APPLICABILITY OF THE INVENTION

The invention relates to a system for integrating digital twins into Vehicular Ad Hoc Networks (VANET) with computer-aided machine learning and data analysis techniques, and a method for operating said system, and is applicable to industry.

The invention is not limited to the above-mentioned exemplary embodiments, and one skilled in the art can easily come up with other different embodiments of the invention. These should be considered within the scope of the protection sought by the claims of the invention.

1. A system for integrating digital twins into vehicular ad hoc networks (VANET) with computer-aided machine learning including at least one processor, characterized in that it comprises;
at least one physical vehicular ad hoc networks (VANET) module (1), which includes vehicles (2), infrastructure unit (3) and pedestrians (4) for real-time data exchange and connection between network elements,
at least one non-autonomous or autonomous vehicle (2) which can communicate with its environment via WiFi or cellular connections,
at least one infrastructure unit (3) which can communicate with its environment and collect data using WiFi or cellular connections,
at least one pedestrian (4) communicating with the network elements with at least one mobile phone,
at least one cloud-based, edge-based or hybrid-based server (5) including vehicular ad hoc networks (VANET) therein,
at least one physical layer unit (6) which realizes the connection between the physical layer of the vehicular digital twins and the physical vehicular ad hoc networks (VANET) module (1) using intra-digital twin communication,
at least one virtual layer unit (7) which creates a virtual representation of the physical vehicular ad hoc networks (VANET) module (1) and processes the received data with computer-aided machine learning,
at least one simulated and real-time visualized digital vehicular ad hoc networks (VANET) module (8) which uses intra-digital twin networks to communicate with virtual elements within the vehicular digital twins,
at least one decision layer unit (9) which makes informed decisions using the analysis from the virtual layer unit (7) and makes optimized recommendations for the physical world through inter-twin communication.

2. A system according to claim 1, characterized in that it comprises network elements including vehicle-to-vehicle (V2V), vehicle-to-infrastructure (V2I/I2V), vehicle-to-pedestrian (V2P/P2V) and infrastructure-to-pedestrian (I2P/P2I) connections.

3. A system according to claim 1, characterized in that it comprises an infrastructure unit (3) including roadside units (RSU), traffic lights, edge fog elements and access points.

4. A method to enable the operation of the system for integrating digital twins into vehicular ad hoc networks (VANET) with computer-aided machine learning including at least one processor, characterized in that it comprises the process steps of;
Communication and data exchange of the vehicles (2), infrastructure unit (3) and pedestrians (4) within the physical VANET module (1) over WiFi, cellular vehicle-to-vehicle (V2V), vehicle-to-infrastructure (V2I/I2V), vehicle-to-pedestrian (V2P/P2V) or infrastructure-to-pedestrian (I2P/P2I) connections (1001),
The infrastructure unit (3) collecting data received from the vehicles (2) and pedestrians (4) within its area and processing these data on the server (5) (1002),
Collecting and filtering said data received by the physical layer unit (6) of the digital twin on the server (5) (1003),
Transmitting the filtered data outputs to the virtual layer unit (7) and visualizing and simulating said data in the virtual layer unit (7) (1004),
Processing the data in the virtual layer unit (7) with computer-aided machine learning and digital vehicular ad hoc networks (VANET) module (8) in the decision layer unit (9) (1005),
Sending the results and decisions obtained in the server (5) with the decision layer unit (9) back to the infrastructure unit (3) (1006),
The infrastructure unit (3) transmitting responses to the components within the physical VANET module (1) (1007),
Adjusting the status of the physical VANET module (1) components according to the received data and updating the number of neighbours thereof and the location and speed data of these neighbours (1008).

5. A method according to claim 4, characterized in that it comprises the process step of performing the data visualization and simulation with the SUMO (simulation of urban mobility analysis system) simulators in the virtual layer unit (7).

6. A method according to claim 4, characterized in that it comprises the process step of displaying the real-time emulated virtual network twin (8) to transport system authorities and system users.
